(19) United States
(12) Patent Application Publication
(10) Pub. No.: US 2018/0096357 A1
(43) Pub. Date: Apr. 5, 2018

(54) DIGITAL COUPON SYSTEM FOR SMART PHONES

(71) Applicant: Jason A. Ashton, Santa Cruz, CA (US)

(72) Inventor: Jason A. Ashton, Santa Cruz, CA (US)

(21) Appl. No.: 15/821,250

(22) Filed: Nov. 22, 2017

Related U.S. Application Data
(63) Continuation of application No. 14/088,060, filed on Nov. 22, 2013, now abandoned.

(51) Int. Cl. G06Q 30/00; G06Q 30/02

(52) U.S. Cl. CPC G06Q 30/00; G06Q 30/0207; G06Q 30/0267

(57) ABSTRACT

A phone is adapted to receive a digital coupon for a business after the business is called with the phone. The digital coupon is displayed in one of a call log, call screen or contacts at a position associated with the business.

### CROSS REFERENCE TO RELATED APPLICATIONS

This application is a continuation of U.S. patent application Ser. No. 14/088,060 filed on Nov. 22, 2013, the disclosure of which is hereby incorporated herein by reference in its entirety.

### BACKGROUND

A Smartphone is a high-end mobile phone that offers advanced computing ability and connectivity. Smartphones combine the functions of a personal digital assistant (PDA) and a mobile phone. Today's models typically also serve as portable media players and camera phones with high-resolution touchscreen, GPS navigation, Wi-Fi and mobile broadband access. Smartphones use mobile operating systems that can run third-party applications.

Growth in demand for advanced mobile devices boasting powerful processors and graphics processing units, abundant memory, and high-resolution screens with multi-touch capability, and open operating systems has outpaced the rest of the mobile phone market for several years. Over 45.5 million people in the United States own Smartphones out of 234 million total subscribers.

### SUMMARY

Embodiments of the present invention concern a system that provides digital coupons to smartphones. These digital coupons can be displayed in a digital calling card display, in a contacts list or in a display of incoming calls.

### BRIEF DESCRIPTION OF THE DRAWINGS

FIG. 1 shows an exemplary digital coupon display along with a digital calling card.

FIG. 2 shows another exemplary display of a digital coupon.

FIG. 3 shows an exemplary display of a digital coupon in a contacts list.

FIG. 4 shows an exemplary display of a digital coupon in a called list.

FIG. 5-7 show additional exemplary displays of a digital coupons

FIG. 8 shows a digital calling card of one embodiment.

FIG. 9 shows an exemplary system of one embodiment of the present invention

FIG. 10 shows an alternate system of one embodiment of the present invention.

### DETAILED DESCRIPTION OF ILLUSTRATIVE EMBODIMENTS

Embodiments of the present invention include the use of digital coupons. In one embodiment, a digital coupon is received for a business. This can be done after a user calls the business with a phone. The digital coupon can then be displayed at the phone. The digital coupon can be displayed at one of a call log, call screen or contacts at a position associated with the business.

The phone, such as a smart phone, can be adapted to receive a digital coupon for the business and to display the digital coupon in one of a call log, call screen or contacts at a position associated with the business.

In one embodiment, a digital gift is received at a phone. At the phone, the digital gift can be displayed in one of a call log, call screen or contacts. The digital gift can be a digital coupon or gift certificate.

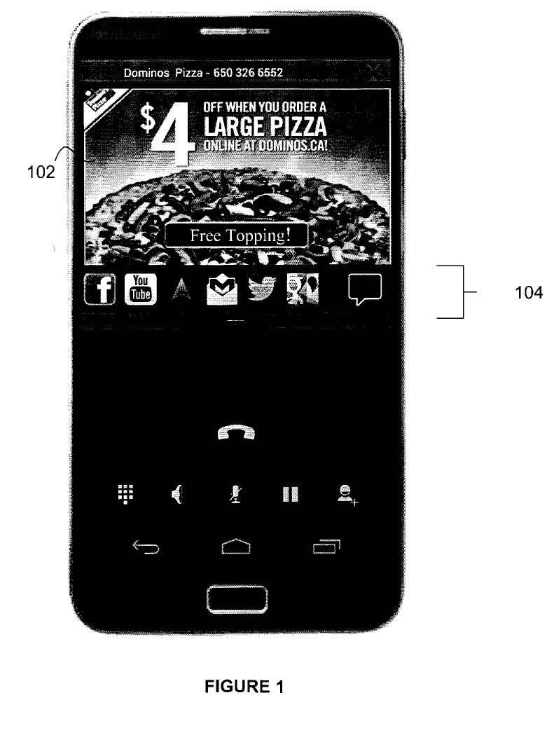

FIG. 1 shows a digital coupon 102 in a region associated with a digital calling card displayed when a call is sent or received.

The digital coupons can be dynamic. They can change over time in response to a time trigger or as a result of events at the phone (such as a user looking at a contact list) or an external event. Dynamic coupons can be loaded one time to update in response to events or can be updated one or more times externally. Updated or new coupons can be loaded from a business or at times advantageous to the business, such as in response to slow periods at the business.

A server associated with a mobile phone system can send the digital coupon to the phone for example upon a call being made to the business. In one embodiment, coupons can be sent by dialing, such as auto-dialing, from the business. Such auto-dialing can automatically send the coupon to the phone without ringing the phone. The digital coupon can include a code or some other information to allow the coupon to be digitally or manually redeemed.

In the example of FIG. 1, the coupon 102 can be displayed in a location that would be used for the digital calling card. The coupon can be displayed for a period of time before the digital display of the normal calling card display starts or is resumed. In one embodiment, the coupon can be displayed in a portion of the display and the normal digital calling card image displayed in the other portion of the display.

Dynamic Icons 104 can be used with the digital calling card. The Dynamic Icons 104 can be linked to data associated with a caller. The Dynamic Icons 104 can include links to social networking data, map application, videos and communication links related to the subject of the digital calling card.

Digital calling cards are discussed in U.S. application Ser. No. 13/547,224 entitled: “PHONE WITH MULTI-PORTAL ACCESS FOR DISPLAY DURING INCOIMG AND OUTGOING CALL”, by Jason A. Ashton, filed Jul. 12, 2012, which is incorporated herein by reference.

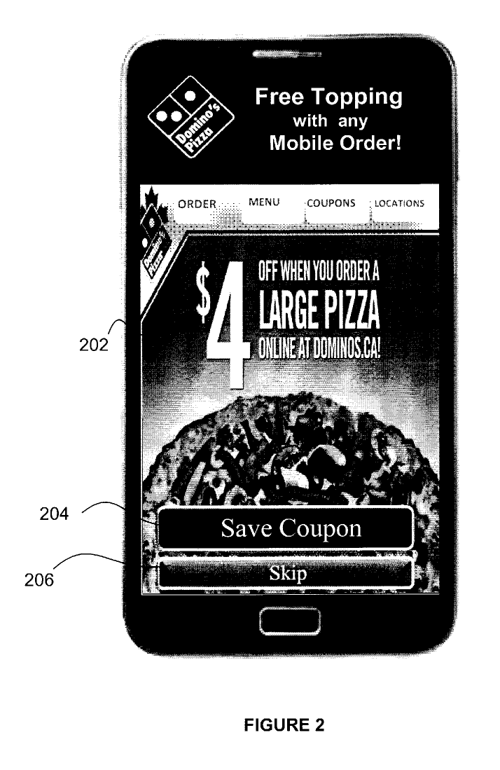

FIG. 2 shows a coupon 202 that can be saved with button 204 or skipped with button 206.

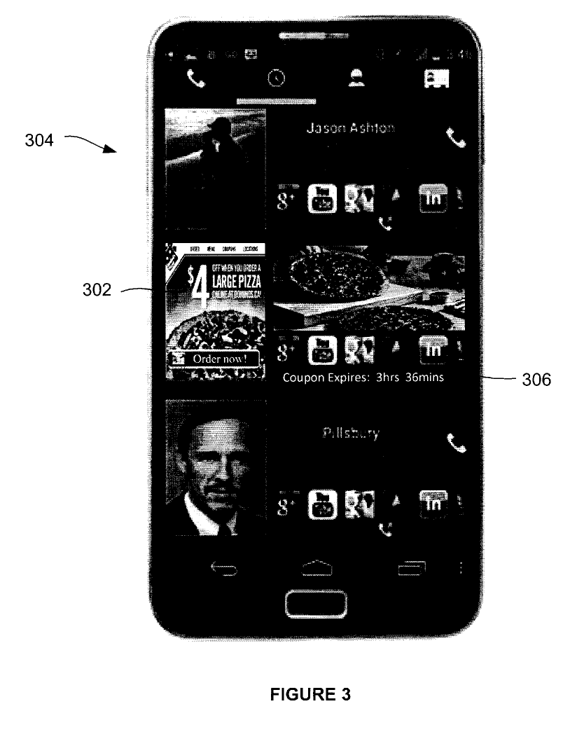

The digital coupon can also be displayed in a contacts list 304, as shown in FIG. 3. When a call is received or sent, the coupon can be sent for a business associated with the call. This coupon can then be displayed in a contacts list 304.

In the example of FIG. 3, the coupon 302 is associated with an expiration time 306. After the expiration time is over, the coupon can be removed from the display such as the contacts list 304. The coupon can also be displayed and/or removed after a period of time or in response to some event. The digital coupon can be associated with logic that displays the digital coupon for a period of time. The logic can start displaying the digital coupon after a condition is met; such a condition can be a period of time without calling the business. The logic can stop displaying the digital coupon after another condition is met, such as when a period of time expires.

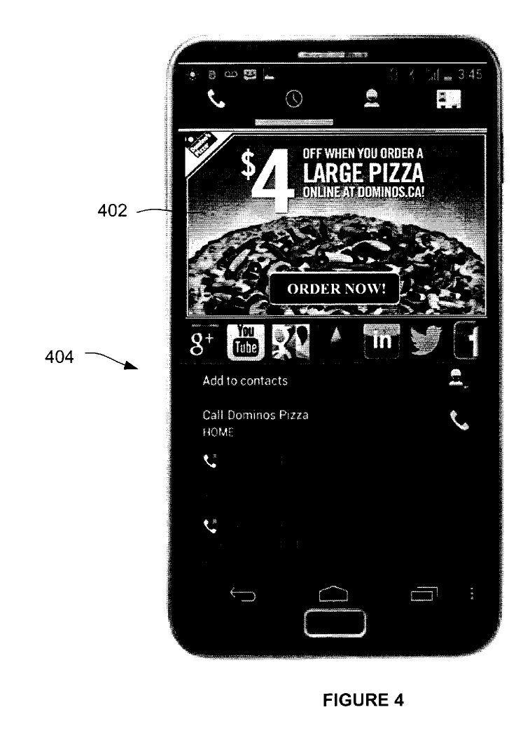

As shown in FIG. 4, the coupon 402 can also be displayed in a call list 404 that indicates recently sent and received calls.

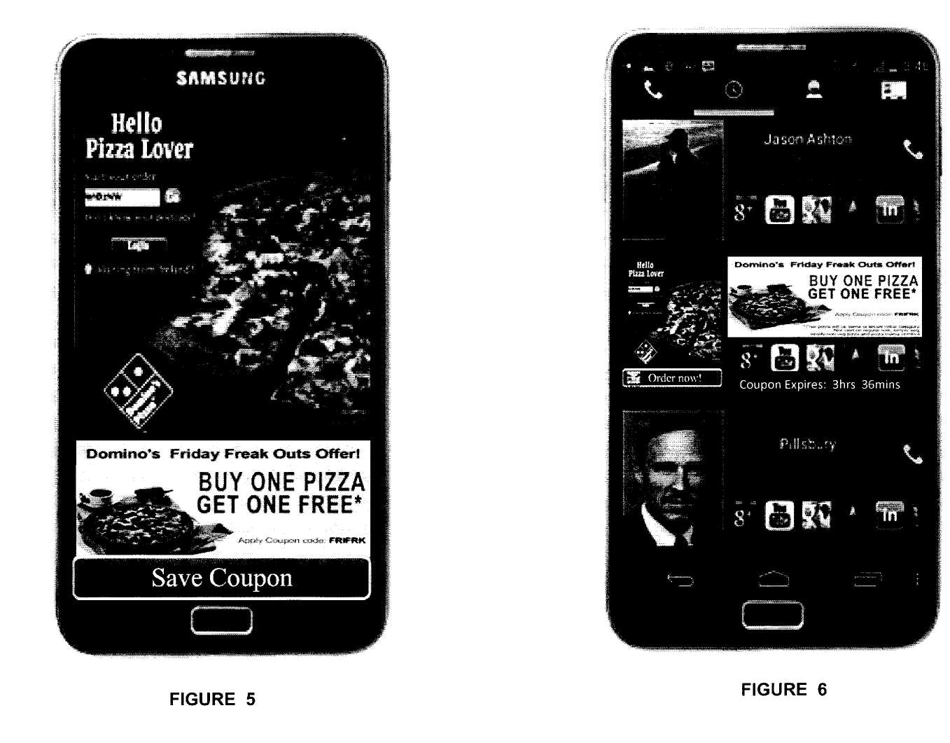

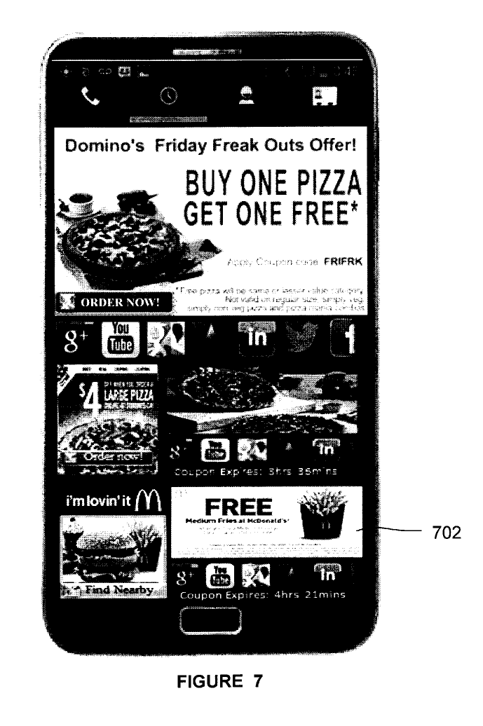

FIGS. 5-7 show alternate displays of coupons. In example of FIG. 7, a coupon for a competitor 702 is displayed. The system can allow for competitor and other third party coupons to be displayed as a result of an interaction with a business.

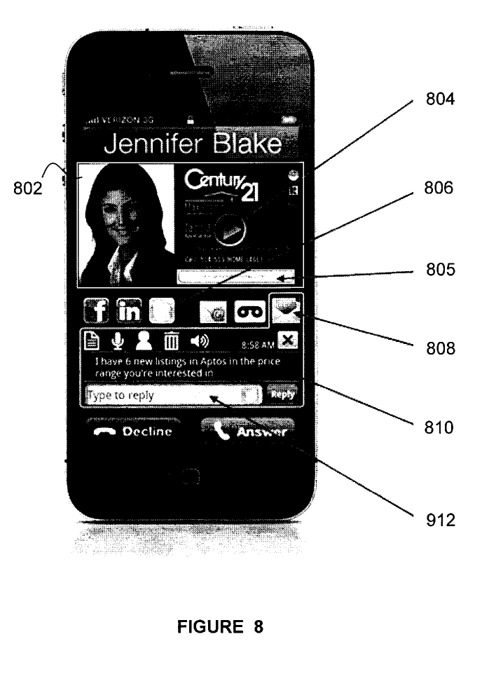

FIG. 8 shows an example of a digital calling card. An exemplary display 802 that can be provided to a party to a call. This display includes an image 804. An image center can be used to enable callers to attach and send images and video as part of the caller's ID. Dynamic Icons 803 are also shown.

An email access portion 805 can provide a short key to the email address of the other party to the call. Clicking on the email address can send the user to an email page where an email can be sent during the call.

A profile portion 806 can provide access to the profile and social networks of the other party of the call. The profile portion 806 can notify the users of past and recent text, video messages, emails and voicemails related to the other party to the call.

A message portion 808 can provide access to messages from the other party to the call. A message preview section 810 can show preview of past and recent messages, such as emails and text messages. This helps the user to have a context to the call. Reply portion 812 can allow instant reply via email, chat, text, or voicemail.

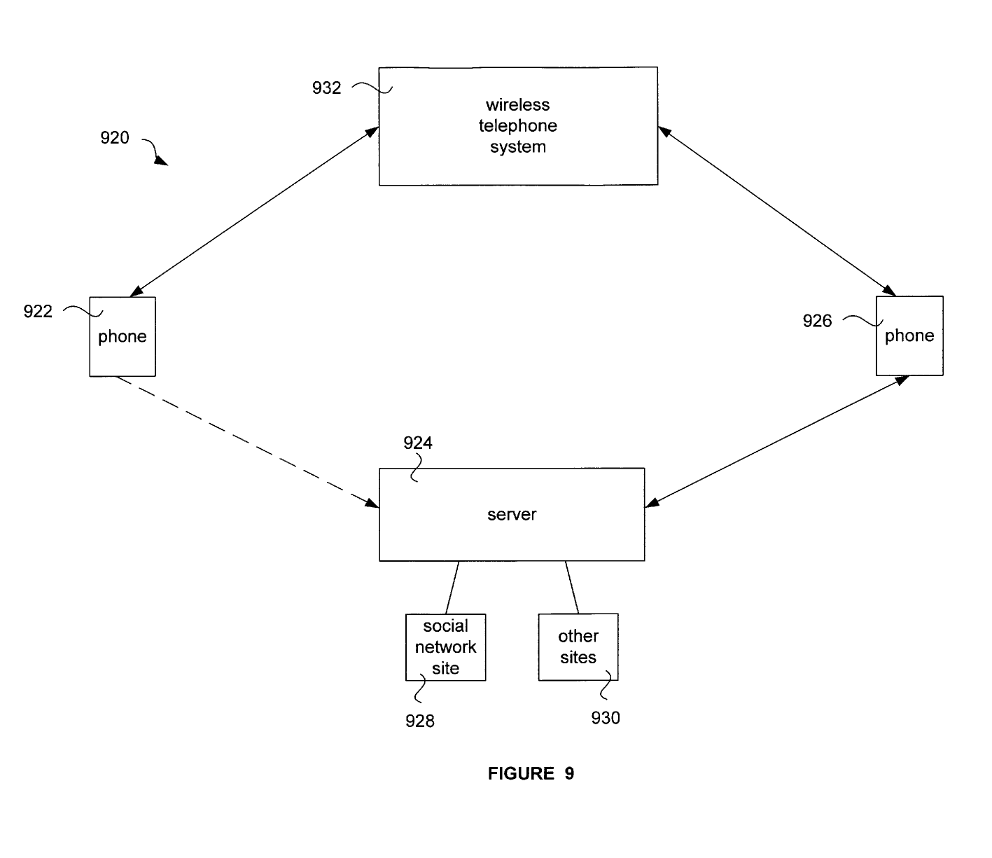

FIG. 9 shows a system 920 for implementing embodiments of the present invention. Phone 922 can register with server 924 to allow for displays such as coupon and/or digital calling card displays to be provided to another phone, such as phone 926. The server 924 can store a correspondence between the telephone number for phone 922 and the data to be displayed at the phone 926.

During an incoming or outgoing call between phone 922 and phone 926. Phone 926 can obtain display information from server 924. The server 924 can obtain updates from social network sites 928 and other sites 930.

Alternately, the server 924 can provide pointers or links to these sites 928 and 930 and the phone can independently get display information from sites 928 and 930. The phone 926 can cache this display information and update it as needed.

The server 924 can be part of or independent of the wireless telephone system 932 setting up the call.

In an alternate embodiment, the digital coupon and/or digital calling card can be directly sent between phone 926 and 922, or be sent through wireless telephone system 1032. Phones can also access website 928 and 930 directly to get digital coupons, digital calling cards, and/or an association between a telephone number and data.

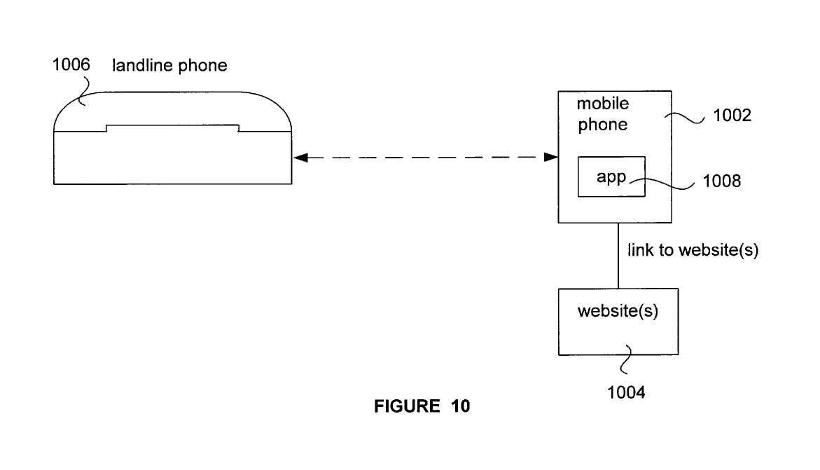

FIG. 10 shows an example where mobile phone 1002 accesses websites 1004 associated with phone 1006. This other phone 1006 can be a landline phone. The phone 1002 can have an app 1008 to handle the digital coupons and/or digital calling cards. The app 1008 can look up the correspondence between phone numbers and user data for a digital calling card and/or coupons from websites 1047. The app 1008 can also obtain digital coupons and/or digital calling cards from websites 1004.

In one embodiment, when a gift certificate is provided, relevant discount coupons can be provided to the user. For example, half-off or other discount coupons can be provided to a user that can be used along with when a provided gift certificate. The phone, such as a smart phone, can be adapted to receive the discount coupons and gift certificates and to display the digital coupon in one of a call log, call screen or contacts at a position associated with the business.

This specification is not intended to be exhaustive or to limit the invention to the precise forms disclosed. Many embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the claims and their equivalents.

What is claimed:

1. A method comprising:
after calling a business with a phone, receiving a digital coupon for the business; and
at the phone, displaying the digital coupon in one of a call log, call screen or contacts at a position associated with the business.

2. The method of claim 1, wherein the digital coupon is displayed in a call log.

3. The method of claim 1, wherein the digital coupon is displayed on a call screen.

4. The method of claim 1, wherein the digital coupon is displayed in the contacts.

5. The method of claim 1, wherein the displaying of the digital coupon is associated with logic that displays the digital coupon for a period of time.

6. The method of claim 5, wherein the logic starts displaying the digital coupon after a condition is met.

7. The method of claim 6, wherein the condition is a period of time without calling the business.

8. The method of claim 5, wherein logic stops displaying the digital coupon after another condition is met.

9. The method of claim 1, wherein the phone supports digital calling cards; and
wherein the coupon is displayed at a location where a digital calling card for the business would be displayed.

10. The method of claim 1, wherein a server associated with a mobile phone system sends the digital coupon to the phone upon a call being made to the business.

11. The method of claim 1, wherein the digital coupon is dynamic.

12. The method of claim 11, wherein the dynamic coupon is provided by a business.

13. The method of claim 1, wherein the digital coupon is associated with a gift certificate.

14. The method of claim 13, wherein the digital coupon is displayed along with the gift certificate.

15. A method comprising:
receiving a digital gift at a phone; and
at the phone, displaying the digital gift in one of a call log, call screen or contacts.

16. The method of claim 15, wherein the digital gift is a digital coupon.

17. The method of claim 16, wherein the digital coupon is received from a business after calling the business.

18. The method of claim 17, wherein the digital coupon is displayed in the in one of a call log, call screen or contacts at a position associated with the business.

19. The method of claim 15, wherein the digital gift is a gift certificate.

20. The method of claim 19, wherein a digital coupon is associated with the gift certificate.

21. The method of claim 15, wherein the digital coupon is displayed along with the gift certificate.

22. The method of claim 15, wherein the digital gift is dynamic.

23. A phone adapted to:
receive a digital coupon for a business after the business is called with the phone, and
display the digital coupon in one of a call log, call screen or contacts at a position associated with the business.

24. The phone of claim 23, wherein the digital coupon is displayed in a call log.

25. The phone of claim 23, wherein the digital coupon is displayed on a call screen.

26. The phone of claim 23, wherein the digital coupon is displayed in the contacts.

27. The phone of claim 23, wherein logic at the phone that displays the digital coupon for a period of time.

28. The phone of claim 23, wherein the phone supports digital calling cards; and wherein the digital coupon is displayed at a location where a digital calling card for the business would be displayed.

29. The phone of claim 23, wherein the digital coupon is dynamic.
